(19) United States
(12) Patent Application Publication
(10) Pub. No.: US 2021/0277296 A1
(43) Pub. Date: Sep. 9, 2021

(54) ADHESIVE COMPOSITION, CURED PRODUCT, AND ARTICLE

(71) Applicant: CANON KABUSHIKI KAISHA, Tokyo (JP)

(72) Inventor: Yasuhiro Tanaka, Tokyo (JP)

(21) Appl. No.: 17/194,124

(22) Filed: Mar. 5, 2021

(30) Foreign Application Priority Data
Mar. 9, 2020 (JP) 2020-039867

(51) Int. Cl. C09J 163/00; C09J 11/08; C08L 5/16; C08K 5/17; C08G 59/24; C08G 59/40; G02B 7/28

(52) U.S. Cl. CPC C09J 163/00; C09J 11/08; C08L 5/16; C08K 5/17; C08G 59/245; C08G 2170/00; C08G 59/4064; G02B 7/28; C09J 2405/00; C09J 2463/00; C08G 59/4014

(57) ABSTRACT

An adhesive composition includes: a clathrate including a cyclodextrin derivative and a guest compound; an epoxy resin; and a tertiary amine having a base dissociation constant of 5.0 or less, wherein the cyclodextrin derivative has an alkoxy group and a substituted or unsubstituted amino group, the guest compound has a substituted or unsubstituted amino group, and the clathrate has a content of 1 part by mass or more and 2.5 parts by mass or less with respect to 100 parts by mass of the epoxy resin.

### BACKGROUND

### Field

The present disclosure relates to an adhesive composition, a cured product, and an article.

### Description of the Related Art

In adhesion between an oscillator of an ultrasonic motor, which is a kind of an actuator, and a piezoelectric element, in order to reduce the thickness of an adhesive layer (hereinafter, it may be referred to as “thin-wall adhesion”), pressure is applied from the piezoelectric element side during adhesion. However, there is such an article in which pressure is not applied to the adhesive surface after an adhesive is poured into a gap with a dispenser like adhesion between the optical lens which is the first member and the lens barrel which is the second member. Conventionally, an acrylic ultraviolet curing adhesive has been used as an adhesive for adhering such an article (Japanese Patent Publication No. H03-60404).

### SUMMARY

A first adhesive composition according to one aspect of an exemplary embodiment in the present disclosure includes a clathrate including a cyclodextrin derivative and a guest compound; an epoxy resin; and a tertiary amine having a base dissociation constant of 5.0 or less, wherein the cyclodextrin derivative has an alkoxy group and a substituted or unsubstituted amino group, the guest compound has a substituted or unsubstituted amino group, and the clathrate has a content of 1 part by mass or more and 2.5 parts by mass or less with respect to 100 parts by mass of the epoxy resin.

Furthermore, a second adhesive composition according to another aspect of an exemplary embodiment in the present disclosure includes a clathrate including a cyclodextrin derivative and a guest compound; an epoxy resin; and a crosslinking curing agent, wherein the cyclodextrin derivative has an alkoxy group and a substituted or unsubstituted amino group, the guest compound has a substituted or unsubstituted amino group, and the clathrate has a content of 0.1 parts by mass or more and 5.0 parts by mass or less with respect to 100 parts by mass of the epoxy resin.

Further features of the present disclosure will become apparent from the following description of exemplary embodiments with reference to the attached drawings.

### BRIEF DESCRIPTION OF THE DRAWINGS

FIG. 1 is a conceptual diagram illustrating an example of a crosslinked portion of a cured product obtained by curing an adhesive composition according to the present embodiment.

FIGS. 2A and 2B are conceptual diagrams illustrating a high elastic modulus and high breaking energy state that a cured product according to the present embodiment develops.

FIG. 3 is a conceptual diagram illustrating a reaction rate of a clathrate with an epoxy resin in a second adhesive composition.

FIG. 4 is a schematic cross-sectional view illustrating an example of an article according to the present embodiment.

### DESCRIPTION OF THE EMBODIMENTS

Since a conventionally used acrylic ultraviolet curing adhesive has high viscosity and low adhesion force, a first member (for example, a lens) sometimes detached from a second member (for example, a housing) when the first member and the second member tried to be thin-wall adhered.

Therefore, in order to adhere a lens to a lens barrel with a thin wall and high strength, it is expected to use an epoxy adhesive having low viscosity and strong adhesion force. However, since an epoxy adhesive is generally hard and brittle, when they are thin-wall adhered with a thickness of 0.1 mm or less, the shrinkage stress of the adhesive during curing after adhesion cannot be relaxed, and a crack may occur to decrease adhesion force.

Hereinafter, components used in the present embodiment will be described.

<<Adhesive Composition>>

### <Clathrate>

A clathrate is a supramolecular clathrate including a cyclodextrin derivative and a guest compound.

Examples of the cyclodextrin derivative include an α-cyclodextrin derivative, a β-cyclodextrin derivative, and a γ-cyclodextrin derivative. As the cyclodextrin derivative, when the guest compound is adamantylamine, a β-cyclodextrin derivative is preferable.

The cyclodextrin derivative has an alkoxy group and a substituted or unsubstituted amino group. In general, the supramolecular clathrate including cyclodextrin and a guest compound chemically bonds in a hydrophilic polymer, so that cyclodextrin has a modified hydroxyl group and is not compatible with an epoxy resin. However, the cyclodextrin derivative in the present embodiment is a compound in which at least part of hydroxyl groups of the cyclodextrin moiety is substituted with an alkoxy group, or a substituted or unsubstituted amino group, so that compatibility with an epoxy resin is improved. It is preferable that the cyclodextrin derivative is a compound in which a plurality of hydroxyl groups of the cyclodextrin moiety is substituted with alkoxy groups. The alkoxy group is not particularly limited, but a methoxy group is preferable from the viewpoint of compatibility with an epoxy resin. The substituted or unsubstituted amino group is not particularly limited, but an unsubstituted amino group is preferable from the viewpoint of reactivity with an epoxy resin.

The guest compound has a substituted or unsubstituted amino group. The substituted or unsubstituted amino group is not particularly limited, but an unsubstituted amino group is preferable from the viewpoint of reactivity with an epoxy resin. As the guest compound, adamantylamines such as 1-adamantylamine are preferable.

In a first adhesive composition, the clathrate has a content of 1 part by mass or more and 2.5 parts by mass or less with respect to 100 parts by mass of an epoxy resin. Furthermore, in a second adhesive composition, the clathrate has a content of 0.1 parts by mass or more and 5.0 parts by mass or less. When the content of the clathrate is within the above range, the clathrate is excellent in low viscosity and enables high-strength thin-walled adhesion. When the clathrate has a content of less than 1 part by mass in the first adhesive composition or the clathrate has a content of less than 0.1 parts by mass in the second adhesive composition with respect to 100 parts by mass of an epoxy resin, the effect of the clathrate is reduced, and the adhesive surface may be released. Furthermore, when the clathrate has a content of more than 2.5 parts by mass in the first adhesive composition or the clathrate has a content of more than 5.0 parts by mass in the second adhesive composition with respect to 100 parts by mass of an epoxy resin, the effect of the clathrate is reduced, the clathrate may have high viscosity.

### <Epoxy Resin>

An adhesive composition according to the present embodiment contains an epoxy resin (prepolymer) as a base resin. The epoxy resin may be any material that is cured by causing a polymerization reaction with a curing agent, and is not particularly limited. Examples of the epoxy resin include epoxy resins such as bisphenol epoxy resins such as a bisphenol A epoxy resin and a bisphenol F epoxy resin, novolak type epoxy resins such as a novolak epoxy resin and cresol novolak epoxy resin, biphenyl type epoxy resins, stillben type epoxy resins, triphenol methane type epoxy resin, alkyl modified triphenol methane type epoxy resin, triazine nucleus-containing epoxy resin, and dicyclopentadiene modified phenol type epoxy resin. Above all, from the viewpoint of adhesive strength, it is preferable to use an epoxy resin having a rigid structure such as a biphenyl skeleton, a bisphenol skeleton, or a stilbene skeleton as a main chain. In particular, it is preferable to use a bisphenol epoxy resin, and among them, it is preferable to use a bisphenol F epoxy resin. This is because the bisphenol epoxy (F) resin has the characteristics of high mechanical strength, good chemical resistance, high curability, and low hygroscopicity due to its small free volume because the crosslink density is high.

### <Curing Agent>

### [First Adhesive Composition]

The first adhesive composition contains a tertiary amine having a base dissociation constant (pKb) of 5.0 or less. In the present specification, the base dissociation constant means the first base dissociation constant (pKb₁) in an aqueous solution with a temperature of 25° C.

When the base dissociation constant of a catalytic curing agent is significantly different from the base dissociation constant of the clathrate, the clathrate tends to agglomerate during mixing. When the clathrate agglomerates, it becomes difficult to exert a stress concentration relaxation effect due to the clathrate described below, and when the amount of the clathrate added is increased to compensate for the effect, the viscosity increases. As a result of studying a method in which the clathrate is difficult to agglomerate and an increase in viscosity can be suppressed, the present inventors have found that the disadvantage can be solved by using a tertiary amine whose base dissociation constant is close to a base dissociation constant of the clathrate as the catalytic curing agent. When the tertiary amine has a base dissociation constant of 5.0 or less, the clathrate can be uniformly dispersed, the amount of the clathrate added can be reduced to suppress the increase in viscosity, and the stress concentration relaxation effect of the clathrate can be fully exerted.

The tertiary amine having a base dissociation constant of 5.0 or less is not particularly limited, and a versatile tertiary amine generally used for curing the epoxy resin can be used. Specifically examples of the tertiary amine include N-methylpiperazine (pKb=3.9), triethylamine (pKb=3.3), tributylamine (pKb=4.0), N,N-diethylbenzylamine (pKb=4.7), N,N′-dimethylpiperazine (pKb=4.8), and 2,4,6-tris(dimethylaminomethyl)phenol (pKb=5.0).

As for the first adhesive composition, it is preferable that the tertiary amine has a content of 0.6 parts by mass or more and 1 part by mass or less with respect to 100 parts by mass of the epoxy resin. When the content of the tertiary amine is within the range, low-viscosity and high-strength thin-walled adhesion is possible.

[Second Adhesive Composition]

The second adhesive composition contains a crosslinking curing agent. The crosslinking curing agent can also be called a polyaddition curing agent.

When the curing agent is the catalytic curing agent, the curing reaction is a self-polymerization reaction of the epoxy resin, so that the molecular size around the reaction point is smaller than the molecular size of a crosslinking curing agent in which the curing agent is incorporated into the skeleton. Therefore, since a reaction rate of a clathrate with the epoxy resin is low, a large amount of the clathrate is required, and the excess clathrate causes the viscosity to increase. As a result of diligent studies on an approach for increasing the reaction rate of the clathrate with the epoxy resin by mixing a small amount of the clathrate, the present inventors have found that the viscosity can be reduced by using a crosslinking curing agent as the curing agent.

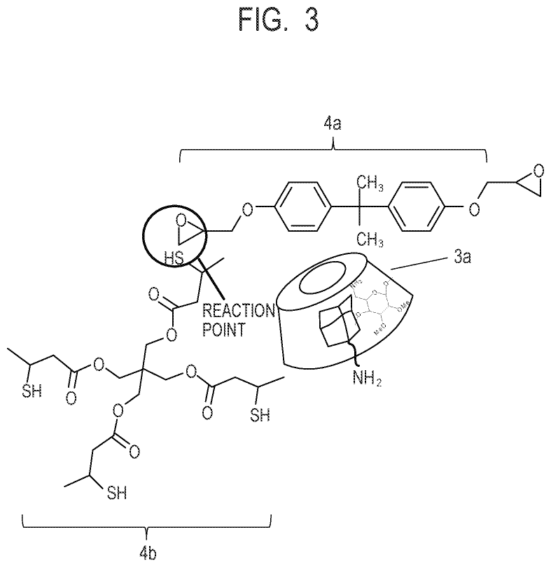

FIG. 3 is a conceptual diagram illustrating a reaction rate of a clathrate with an epoxy resin. FIG. 3 illustrates a clathrate 3a, an epoxy resin 4a, and a crosslinking curing agent 4b. The molecular size (cavity height) of a β-cyclodextrin derivative constituting the clathrate 3a is about 1.0 nm, and the molecular weight of β-cyclodextrin is 1134.99. As illustrated in FIG. 3, in order to bond the clathrate 3a to the binding site (reaction point) of the epoxy resin 4a and the crosslinking curing agent 4b, considering a benzene ring having a molecular size of 0.36 nm per benzene ring, three or more benzene rings are required. As a result of diligent studies, it was clarified that the probability that the clathrate 3a reacts with the epoxy resin 4a increases by using the crosslinking curing agent as the curing agent.

Here, when the molecular size around the reaction point is defined using the equivalent, bisphenol F diglycidyl ether, which is an epoxy resin, has a molecular weight of 312 and two epoxy groups, so that the epoxy equivalent M (molecular weight per epoxy group) is 156.

When a thiol curing agent, for example, pentaerythritol tetrakis(3-mercaptobutyrate) is used as the crosslinking curing agent, it has a molecular weight of 544.76 and four thiol groups, so the equivalent T (thiol equivalent) of the crosslinking curing agent is 136.19. The sum of the epoxy equivalent M and the equivalent T of the crosslinking curing agent is 292.19, and the clathrate can easily enter into an epoxy resin, so that the reaction rate between the clathrate and the epoxy resin is high.

When metaxylene diamine is used as the polyamine-based crosslinking curing agent, the equivalent T (active hydrogen equivalent) of the crosslinking curing agent is 80, and the sum of the epoxy equivalent M and the equivalent T of the crosslinking curing agent is 235. When 3-methyl-1,2,3,6-tetrahydrophthalic anhydride or 4-methyl-1,2,3,6-tetrahydrophthalic anhydride is used as an acid anhydride crosslinking curing agent, the equivalent T (acid anhydride equivalent) of the crosslinking curing agent is 90, and the sum of the epoxy equivalent M and the equivalent T of the crosslinking curing agent is 246.

It is preferable that the sum of the epoxy equivalent M of the epoxy resin and the equivalent T of the crosslinking curing agent is 150 or more because the reaction rate of the clathrate with the epoxy resin is high and the effect can be exerted with a small amount of the clathrate.

As the crosslinking curing agent, a versatile agent generally used for curing an epoxy resin can be used. Moreover, the curing agent may contain a curing accelerator. Examples of the curing agent include a thiol-based curing agent, an amine-based curing agent, an acid anhydride-based curing agent, and a phenol-based curing agent.

Examples of the thiol-based curing agent include a thiol compound obtained by esterification reaction of a mercapto organic acid with polyols such as trimethylolpropane tris(thioglycolate), pentaerythritol tetrakis(thioglycolate), ethylene glycol dithioglycolate, trimethylolpropane tris-thiopropionate), pentaerythritol tetrakis(β-thiopropionate), and dipentaerythritol poly(β-thiopropionate), alkyl polythiol compounds such as 1,4-butanedithiol, 1,6-hexanedithiol, and 1,10-decanedithiol, terminal thiol group-containing polyether, terminal thiol group-containing polythioether, thiol compound obtained by reacting an epoxy compound with hydrogen sulfide, and a thiol compound having a terminal thiol group obtained by reacting a polythiol with an epoxy compound.

Examples of the amine-based curing agent include aliphatic polyamines such as diethylenetriamine, triethylenetetramine, and metaxylylenediamine, aromatic polyamines such as diaminodiphenylmethane, m-phenylenediamine, and diaminodiphenylsulfone, as well as polyamine compounds containing dicyandiamide and organic acid dihydrazide.

Examples of the acid anhydride-based curing agent include alicyclic acid anhydrides such as hexahydrophthalic anhydride and methyltetrahydrophthalic anhydride, and aromatic acid anhydrides such as trimellitic anhydride and benzophenonetetracarboxylic acid.

Examples of the phenol-based curing agent include a phenolic resin.

The content of the crosslinking curing agent is not particularly limited, but is preferably an amount that is stoichiometrically the same as the epoxy equivalent. When the content of the crosslinking curing agent is an amount that is stoichiometrically the same as the epoxy equivalent, low-viscosity and high-strength thin-walled adhesion is possible.

<Viscosity>

The viscosity of the adhesive composition at 25° C. is not particularly limited, and is preferably 15,000 mPa·s or less. When the viscosity is within the range, low-viscosity and high-strength thin-walled adhesion is possible.

<Method of Producing Adhesive Composition>

The method of producing the adhesive composition of the present disclosure is not particularly limited, and for example, can be produced as follows.

First, as for the supramolecular clathrate, a powdery supramolecular clathrate can be produced by stirring the cyclodextrin derivative and the guest compound in water at a molar ratio of, for example, 1:1 and drying the filtrate.

Subsequently, the supramolecular clathrate and the curing agent are added into the same container, and centrifuged until the supramolecular clathrate is dispersed. For centrifuging, for example, a small ultracentrifuge (“CS150GX” manufactured by Hitachi Koki Co., Ltd.) can be used. After centrifuging, the curing agent containing the supramolecular clathrate and the epoxy resin can be mixed and degassed to produce an adhesive composition. For mixing and degassing, for example, a planetary rotating device (“AR-100” manufactured by THINKY CORPORATION) can be used.

Furthermore, the supramolecular clathrate, the epoxy resin and the curing agent can be added into the same container and centrifuged until the supramolecular clathrate is dispersed to produce an adhesive composition.

<<Cured Product>>

The cured product according to the present embodiment is obtained by curing the above-mentioned adhesive composition. More specifically, the cured product of the present embodiment has a crosslinking point formed by the above-mentioned clathrate.

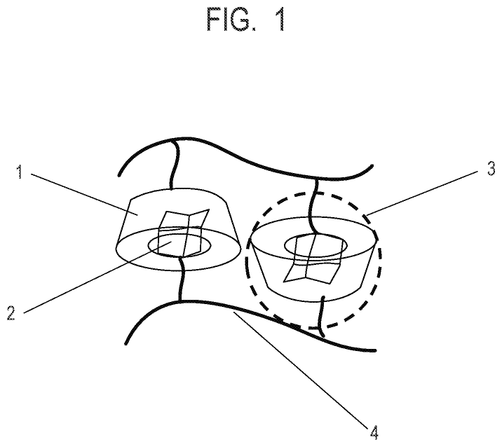

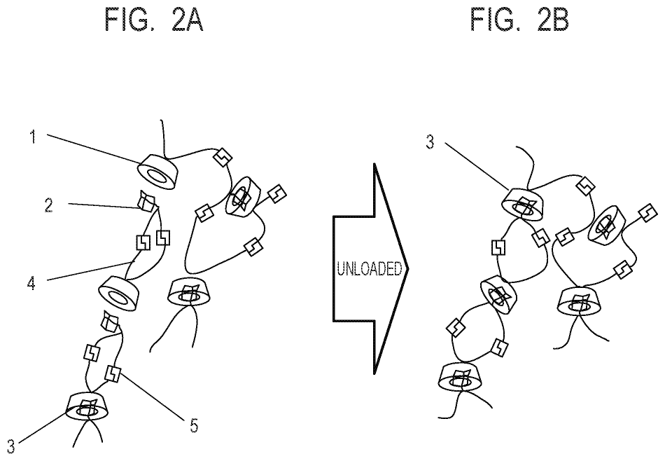

FIG. 1 is a conceptual diagram illustrating an example of a crosslinked portion of a cured product obtained by curing the adhesive composition according to the present embodiment. FIGS. 2A and 2B are conceptual diagrams illustrating a high elastic modulus and high breaking energy state that a cured product according to the present embodiment develops. FIGS. 1, 2A and 2B illustrate a cyclodextrin derivative 1, a guest compound (1-adamantylamine in the example) 2, a non-covalent crosslinking point 3, a chain polymer 4, and a covalent crosslinking point 5. As illustrated in FIG. 1, the non-covalent crosslinking point 3 is formed by a supramolecular clathrate including the cyclodextrin derivative 1 and the guest compound 2. Furthermore, as illustrated in FIGS. 2A and 2B, in the cured product of the present disclosure, a three-dimensional network structure in which the chain polymers 4 are crosslinked by the non-covalent crosslinking point 3 and the covalent crosslinking point 5 is formed.

In the conventional cured product, in order to increase mechanical strength and the like, a three-dimensional network structure in which chain polymers are crosslinked by a covalent crosslinking point is formed. When stress is applied to the conventional cured product, the stress tends to concentrate on a short portion of the three-dimensional network (covalent crosslinking point), so that damage is likely to occur. Furthermore, the bond at the covalent crosslinking point cannot be restored once it is broken, so that breaking energy is low.

Since the cured product according to the present embodiment has the non-covalent crosslinking point 3 in addition to the covalent crosslinking point 5, as illustrated in FIG. 2A, the cyclodextrin derivative 1 which is a host compound deviates from the guest compound 2 and has an effect of relaxing stress concentration when an external force is applied. Furthermore, as illustrated in FIG. 2B, when the external force is unloaded, the uncoupled cyclodextrin derivative 1 and the guest compound 2 become a supramolecular clathrate again and form the non-covalent crosslinking point 3. As described above, the non-covalent crosslinking point 3 has a buffering action, so that the cured product has a high elastic modulus and high breaking energy. That is, the cured product has an elastic modulus equivalent to that of the conventional epoxy adhesive, and has increased breaking energy and improved toughness.

The cured product preferably has a breaking energy of 200 MJ/m³ or more when the thickness is 0.1 mm. When the breaking energy is within the range, high-strength thin-walled adhesion is possible.

<<Article (Optical Equipment)>>

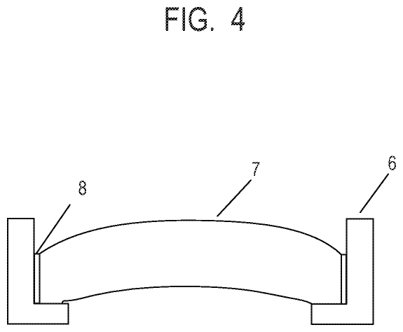

The article according to the present embodiment has a first member and a second member, and has the above-mentioned cured product interposed between the first member and the second member. FIG. 4 is a schematic cross-sectional view illustrating an example of an optical equipment which is an aspect of the article according to the present embodiment. The optical equipment of FIG. 4 has a lens barrel 6 which is a housing as the second member and an optical lens 7 which is a lens as the first member, and has an adhesive portion 8 in which the adhesive composition according to this embodiment was filled and cured in the gap between the lens barrel 6 and the optical lens 7. The adhesive composition according to the present embodiment can be suitably used as an adhesive for optical equipment, and can be used, for example, for thin-walled adhesion between a lens and a lens barrel.

### EXAMPLES

Next, the present embodiment will be specifically described with reference to Examples and Comparative Examples.

### Example 1 (First Adhesive Composition)

The compounds used in Examples and Comparative Examples and the evaluation methods are as follows.

<Compounds>

### [Epoxy Resin (Base Resin of Two-Pack Heat-Curing Adhesive)]

Epoxy Resin 1A: Bisphenol F Epoxy Resin

### [Curing Agent (Curing Agent for Two-Pack Heat-Curing Adhesive)]

Curing agent 1A: N,N-diethylbenzylamine (manufactured by Tokyo Chemical Industry Co., Ltd., PKb=4.7)

Curing agent 1B: 2,4,6-tris(dimethylaminomethyl)phenol (PKb=5.0)

<Synthesis of Supramolecular Clathrate>

A β-cyclodextrin derivative in which 20 were substituted with methoxy groups and one was substituted with an amino group among the hydroxyl groups of β-cyclodextrin moiety and 1-adamantylamine, which is a guest compound, were added in a 50 mL eggplant flask with a stir bar at a molar ratio of 1:1, and water was added. After stirring while heating using a hot water bath, the obtained solution was removed from the hot water bath and returned to room temperature, and then filtered. The supramolecular clathrate (pKb=3.1) was obtained by drying the obtained filtrate.

<Evaluation Methods>

### [Viscosity]

The viscosity of the adhesive composition was evaluated using a viscometer. The device used was a cone/plate viscometer (model: TV-25) manufactured by Toki Sangyo Co., Ltd. The rotor used was 3°×R14, and the measurement was performed under the conditions of a rotation speed of 10 rpm and a measurement temperature of 25±1° C.

[Filling Property]

As an evaluation of the thin-walled adhesion, a filling property of the adhesive composition to the gap between the lens barrel 6 and the optical lens 7 was evaluated as illustrated in FIG. 4. Specifically, first, the adhesive composition is added in a syringe having a capacity of 5 cm³, and the syringe is set in a dispenser coating device. The diameter of the nozzle attached to the syringe was set to an outer diameter of 0.08 mm and an inner diameter of 0.05 mm so that the nozzle can be inserted into the gap of 0.1 mm between the lens barrel 6 and the optical lens 7, and the coating amount was adjusted by the air pressure and time of the dispenser. The filling amount of the adhesive composition was calculated in advance, when the filling amount was as calculated, it was designated as “A”, and when the filling amount was less than the calculated value, it was designated as “B”.

[Adhesion Force]

The adhesion force during thin-walled adhesion was evaluated by an impact resistance test. As evaluation samples, a polycarbonate plate used as a lens barrel member and a glass plate used as an optical lens material were used. A coating film of an internal antireflection paint (“GT-7II”, manufactured by Canon Optron, Inc.) is preliminarily formed on an adhesive side surface of the glass plate. The polycarbonate plate and the glass plate are coated with an adhesive composition so that the thickness of the adhesive layer was 0.1 mm, and then was placed in a constant temperature dryer set at 80° C. in advance to cure the adhesive layer. The curing conditions of the adhesive layer are at 80° C. for 30 minutes. After taking the polycarbonate plate and the glass plate out from the constant temperature dryer, the impact resistance test was performed. As test conditions, a pendulum type impact tester was used, and a released state of the adhesive portion was observed after applying an impact of 400 G 10 times. When there was no release of the adhesive portion, the adhesion force was designated as “A”, and when release occurred, the adhesion force was designated as “B”.

### Example 1-1

In a 100 ml tube for a centrifuge, 1 part by mass (1.0 g) of the supramolecular clathrate was added, and then 0.6 parts by mass (0.6 g) of a curing agent 1A was added into the same tube. After lightly stirring the mixture with a spatula, the tube was set in a small ultracentrifuge (“CS150GX” manufactured by Hitachi Koki Co., Ltd.). In order to uniformly disperse the supramolecular clathrate, centrifugation was performed at 13,000 rpm for 1 hour. After centrifugation, the obtained supramolecular clathrate-containing curing agent 1A and 100 parts by mass (100 g) of an epoxy resin 1A, which is a base resin, are mixed by a planetary rotating device (“AR-100” manufactured by THINKY CORPORATION) for 3 minutes and degassed to obtain an adhesive composition. The obtained adhesive composition was evaluated by the above method. The evaluation results are shown in Table 1.

### Example 1-2, Comparative Example 1-1, and Comparative Example 1-2

An adhesive composition was produced and evaluated in the same manner as in Example 1-1, except that the formulation was changed as shown in Table 1. The results are shown in Table 1.

TABLE 1

| | | | Examples | | Examples Comparative | |
|---|---|---|---|---|---|---|
| | | | 1-1 | 1-2 | 1-1 | 1-2 |
| Materials | Epoxy resin [parts by mass] | | 100 | 100 | 100 | 100 |
| | Curing agents | Curing agent 1A | 0.6 | 0 | 1 | 1 |
| | | (PKb = 4.7) | | | | |
| | | [parts by mass] | | | | |
| | | Curing agent 1B | 0 | 1 | 0 | 0 |
| | | (PKb = 5.0) | | | | |
| | | [parts by mass] | | | | |

| | | | | | |
|---|---|---|---|---|---|
| | Clathrate [parts by mass] | 1 | 2.5 | 0.1 | 5 |
| Evaluations | Viscosity [mPa · s] | 9,600 | 13,500 | 6,250 | 31,000 |
| | Filling property | A | A | A | B |
| | Adhesion force | A | A | B | A |

### Example 2 (Second Adhesive Composition)

The compounds used in Examples and Comparative Examples and the evaluation methods are as follows.

<Compounds>

### [One-Pack Heat-Curing Epoxy Adhesive]

A one-pack heat-curing adhesive including a bisphenol F epoxy resin and a thiol-based crosslinking curing agent (“WR9152D3S” manufactured by Kyoritsu Chemical & Co., Ltd.)

### [Epoxy Resin]

Epoxy Resin 2A: Bisphenol F Epoxy Resin

### [Catalytic Curing Agent]

Curing Agent 2A: Imidazole-Based Curing Agent

<Synthesis of Supramolecular Clathrate>

A supramolecular clathrate was obtained in the same manner as in Example 1. The supramolecular clathrate had a molecular size (cavity height) of about 1.0 nm.

<Evaluation Methods>

[Viscosity]

The viscosity was evaluated in the same manner as in Example 1.

[Filling Property]

The filling property was evaluated in the same manner as in Example 1.

[Adhesion Force]

An evaluation sample was prepared in the same manner as in Example 1, except that the curing conditions of the adhesive layer were changed at 120° C. for 30 minutes. A released state of the adhesive portion was observed after applying an impact of 400 G 10 times, and evaluated in the same manner as in Example 1 after further applying an impact of 800 G five times.

### Example 2-1

In a 100 ml tube for a centrifuge, 0.1 parts by mass (0.01 g) of the supramolecular clathrate was added, and then a one-pack heat-curing epoxy adhesive equivalent to 100 parts by mass of an epoxy resin was added into the same tube. After lightly stirring the mixture with a spatula, the tube was set in the same small ultracentrifuge as in Example 1. In order to uniformly disperse the supramolecular clathrate, centrifugation was performed at 13,000 rpm for 1 hour to obtain an adhesive composition. The evaluation results are shown in Table 2.

### Example 2-2

An adhesive composition was produced and evaluated in the same manner as in Example 2-1, except that the formulation was changed as shown in Table 2. The results are shown in Table 2.

TABLE 2

| | | Examples | |
|---|---|---|---|
| | | 2-1 | 2-2 |
| Materials | Epoxy resin [parts by mass] | 100 | 100 |
| | Epoxy equivalent M | 90 | 90 |
| | Equivalent T of crosslinking curing | 136.19 | 136.19 |
| | agent | | |
| | M + T | 226.19 | 226.19 |
| | Clathrate [parts by mass] | 0.1 | 1 |
| Evaluations | Viscosity [mPa · s] | 7,500 | 12,500 |
| | Filling property | A | A |
| | Adhesion force | A | A |

### Comparative Example 2

### Comparative Example 2-1

In Example 2-1, instead of the one-pack heat-curing epoxy adhesive, 100 parts by mass (10 g) of an epoxy resin 2A and 5 parts by mass (0.5 g) of a curing agent 2A were lightly stirred and added into a tube, and the formulation amount of the clathrate was changed as shown in Table 3. Except that, an adhesive composition was produced and evaluated in the same manner as in Example 2-1. The results are shown in Table 3.

### Comparative Example 2-2

In Example 2-1, instead of the one-pack heat-curing epoxy adhesive, 100 parts by mass (10 g) of the epoxy resin 2A and 1 part by mass (0.1 g) of the curing agent 2A were lightly stirred and added into a tube, and the formulation amount of the clathrate was changed as shown in Table 3. Except that, an adhesive composition was produced and evaluated in the same manner as in Example 2-1. The results are shown in Table 3.

TABLE 3

| | | Comparative Examples | |
|---|---|---|---|
| | | 2-1 | 2-2 |
| Materials | Epoxy resin [parts by mass] | 100 | 100 |
| | Curing agent 2A [parts by mass] | 5 | 1 |
| | Clathrate [parts by mass] | 5 | 1 |
| Evaluations | Viscosity [mPa · s] | 30,500 | 10,500 |
| | Filling property | B | A |
| | Adhesion force | A | B |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-039867, filed Mar. 9, 2020, which is hereby incorporated by reference herein in its entirety.

What is claimed is:

1. An adhesive composition comprising:
a clathrate including a cyclodextrin derivative and a guest compound;
an epoxy resin; and
a tertiary amine having a base dissociation constant of 5.0 or less,
wherein the cyclodextrin derivative has an alkoxy group and a substituted or unsubstituted amino group,
the guest compound has a substituted or unsubstituted amino group, and
the clathrate has a content of 1 part by mass or more and 2.5 parts by mass or less with respect to 100 parts by mass of the epoxy resin.

2. The adhesive composition according to claim 1, wherein the tertiary amine has a content of 0.6 parts by mass or more and 1 part by mass or less with respect to 100 parts by mass of the epoxy resin.

3. The adhesive composition according to claim 1, wherein the cyclodextrin derivative is a compound in which at least part of hydroxyl groups of a cyclodextrin moiety is substituted with an alkoxy group or an amino group.

4. The adhesive composition according to claim 3, wherein the cyclodextrin derivative is a compound in which a plurality of hydroxyl groups of the cyclodextrin moiety is substituted with alkoxy groups.

5. The adhesive composition according to claim 1, wherein the alkoxy group of the cyclodextrin derivative is a methoxy group.

6. The adhesive composition according to claim 1, wherein the guest compound is 1-adamantylamine.

7. The adhesive composition according to claim 1, wherein the epoxy resin is a bisphenol epoxy resin.

8. An adhesive composition comprising:
a clathrate including a cyclodextrin derivative and a guest compound;
an epoxy resin; and
a crosslinking curing agent,
wherein the cyclodextrin derivative has an alkoxy group and a substituted or unsubstituted amino group,
the guest compound has a substituted or unsubstituted amino group, and
the clathrate has a content of 0.1 parts by mass or more and 5.0 parts by mass or less with respect to 100 parts by mass of the epoxy resin.

9. The adhesive composition according to claim 8, wherein the sum of an epoxy equivalent M of the epoxy resin and an equivalent T of the crosslinking curing agent is 150 or more.

10. The adhesive composition according to claim 8, wherein the crosslinking curing agent is a thiol-based curing agent.

11. The adhesive composition according to claim 8, wherein the cyclodextrin derivative is a compound in which at least part of hydroxyl groups of a cyclodextrin moiety is substituted with an alkoxy group or an amino group.

12. The adhesive composition according to claim 11, wherein the cyclodextrin derivative is a compound in which a plurality of hydroxyl groups of the cyclodextrin moiety is substituted with alkoxy groups.

13. The adhesive composition according to claim 8, wherein the alkoxy group of the cyclodextrin derivative is a methoxy group.

14. The adhesive composition according to claim 8, wherein the guest compound is 1-adamantylamine.

15. The adhesive composition according to claim 8, wherein the epoxy resin is a bisphenol epoxy resin.

16. A cured product produced by curing the adhesive composition according to claim 1.

17. A cured product produced by curing the adhesive composition according to claim 8.

18. An article comprising:
a first member;
a second member; and
the cured product according to claim 16 interposed between the first member and the second member.

19. An article comprising:
a first member;
a second member; and
the cured product according to claim 17 interposed between the first member and the second member.
